(19) United States
(12) Patent Application Publication
(10) Pub. No.: US 2011/0145072 A1
(43) Pub. Date: Jun. 16, 2011

(54) System and Method for Producing And Displaying Content Representing A Brand Persona

(76) Inventors: Bradley John Christiansen, Robina (AU); Claes JM Loberg, Terranora (AU)

(21) Appl. No.: 12/969,580

(22) Filed: Dec. 15, 2010

(30) Foreign Application Priority Data
Dec. 15, 2009 (AU) 2009906116

(51) Int. Cl. G06Q 30/00

(52) U.S. Cl. 705/14.66

(57) ABSTRACT

A computer implemented method for producing and displaying content representing a brand persona, the method including the steps of providing at least one consumer database containing a plurality of consumer profiles with consumer preference identifying data stored on a data storage device, providing at least one brand database containing details of brand clients, each having one or more branding parameters stored on a data storage device, providing at least one content database containing a plurality of pieces of content provided by at least one content provider with each piece of content having one or more content profile identifiers stored on a data storage device, a brand specific interface accessible by at least one consumer, the brand specific interface generated by a data processor by matching at least one branding parameter of a brand client with one or more pieces of content and displaying the pieces of content on a branded interface presented to a consumer at no cost to the consumer whilst charging an advertising fee to the brand client and paying a content provision fee to the content provider, the content provided without the branding disrupting or interrupting the content.

### CROSS-REFERENCE TO RELATED APPLICATIONS

The present application claims priority from Australian Patent Application No. 2009906116 filed Dec. 15, 2009, which is incorporated herein by reference in its entirety for all purposes.

### FIELD

The present invention relates to computer implemented systems and methods for generating a brand specific interface for displaying content drawn from a larger pool of content based on parameters set by a particular brand client with each piece of content provided to a consumer conveying a brand persona of the brand client.

### BACKGROUND ART

The ease in which the media can be electronically copied and shared has changed the face of the entertainment industry world-wide. The issue is one of the most controversial to arise from the growth of the Internet. As intellectual property and copyright owners lose increasing amounts of royalties each year, from both declining sales and increasing online piracy, they are demanding better protection from law makers, courts and third parties to assist them in curtailing the practice of unchecked digital content sharing.

As rapidly as the industry has identified “solutions” such as digital rights management (DRM) and encryption, innovative software developers find counter solutions. Through loopholes in the laws, the illegal download market for music alone has grown to approximately 6 billion downloads per annum. When the sum of music, television, film and books, the amount of illegal downloading is growing in popularity and no end is in sight.

At the same time, the advertising market is experiencing significant growth. Whilst US advertising is expected to grow more slowly than the rest of the world, due mainly to its maturity, global spending on advertising is expected to increase to US$653.5 billion aided by above average growth in emerging markets such as China, India and Russia.

However, despite the extra funds, advertisers are demanding greater performance for each advertising dollar. Marketers are now insisting on an immediate ROI on their advertising investments prior to approving the spending. Further, whilst advertising budgets for traditional media such as television and radio have not increased by as much as CPI, strong increases on Internet spending is forecast to continue.

The evolving manner in which consumers are accessing media poses an increasing challenge for the advertising industry as it competes for consumer's attention and time. Advertisers raise spending to put more ads in more places, but that onslaught is turning all marketing messages into mere noise. More and more companies are searching for different ways to spend their marketing dollars by seeking to align where they present their advertising message to media relevant to their market.

Another problem with conventional advertising in relation to digital content is the manner in which advertising is presented to the consumer. The inclusion of advertising in relation to digital media is the major manner in which digital content providers fund the provision of the content. Brand clients that pay for advertising however, want to make sure that the advertising reaches the consumer requesting the digital content. Therefore, the advertising is provided in association with the content in such a way that a consumer sees the advertising in a disruptive manner. For the purposes of the embodiments of the present invention, the term “disruptive” is defined as any method of delivery which a customer doesn't choose to receive or that is undesirable to the customer, this language however is not intended to be a limitation on the term disruptive but is merely explanatory in nature to assist the reader. The advertising is either played before the content is accessible or is embedded into the content or interspersed between portions of the content. All of these ways of providing the advertising disrupt the consumer trying to view or use the content.

A schematic illustration of two types of disruptive advertising is given in FIG. 1.

According to the first type illustrated in FIG. 1A, the advertising appears before the content is delivered requiring a consumer to sit through the advertising before the content is available. There is typically no mechanism to view the content other than by viewing the entirety of the advertising first.

According to the second type illustrated in FIG. 1B, the advertising is interleaved with the content delivery such that the content is interrupted by an advertisement during content delivery.

Both methods of provision are clearly disruptive in nature.

It will be clearly understood that, if a prior art publication is referred to herein, this reference does not constitute an admission that the publication forms part of the common general knowledge in the art in Australia or in any other country.

### SUMMARY

Embodiments of the present invention are directed to systems and methods for producing and displaying content representing a brand persona, which may at least partially overcome at least one of the abovementioned disadvantages or provide the consumer with a useful or commercial choice.

With the foregoing in view, one embodiment of the present invention resides broadly in a computer implemented method for producing and displaying content representing a brand persona, the method including the steps of:
providing at least one consumer database containing a plurality of consumer profiles with consumer preference identifying data stored on a data storage device,
providing at least one brand database containing details of brand clients, each having one or more branding parameters stored on a data storage device,
providing at least one content database containing a plurality of pieces of content provided by at least one content provider with each piece of content having one or more content profile identifiers stored on a data storage device,
a brand specific interface accessible by at least one consumer, the brand specific interface generated by a data processor by matching at least one branding parameter of a brand client with one or more pieces of content and displaying the pieces of content on a branded interface presented to a consumer at no cost to the consumer whilst charging an advertising fee to the brand client and paying a content provision fee to the content provider, the content provided without branding disrupting or interrupting the content.

in another embodiment the present invention resides broadly in a computer implemented brand specific interface generating system for producing and displaying content representing a brand persona, the system including:
at least one consumer database containing a plurality of consumer profiles with consumer preference identifying data stored on a data storage device,
at least one brand database containing details of brand clients, each having one or more branding parameters stored on a data storage device,
at least one content database containing a plurality of pieces of content provided by at least one content provider with each piece of content having one or more content profile identifiers stored on a data storage device, and
a brand specific interface generation engine operating in association with a data processor, and which generates the brand specific interface by matching at least one branding parameter of a brand client with one or more pieces of content and displays the pieces of content on a branded interface presented to a consumer at no cost to the consumer whilst charging an advertising fee to the brand client and paying a content provision fee to the content provider, the content provided without branding disrupting or interrupting the content.

The brand specific interface is generated to display content drawn from a larger pool of content based on parameters set by a particular brand client with each piece of content provided to a consumer conveying a brand persona which the brand client wishes to convey to the consumer to build brand loyalty.

Preferably, the brand interface will contain passive identification of the brand only. It is preferred that any advertising is not embedded or interspersed with any piece of content. Further, the advertising will not require display before, during or after the content but will be passively delivered either through a branded interface and/or through provision of brand matched content having particular consumer contextual tagging to provide a consumer with brand association.

Contextual data or “tags” exist for Brand exposure requirements, the Consumer, and Content.

Examples of Brand contextual data include but are not limited to Brand Industry (eg Food, Alcohol, Mining, etc), Content Types (eg Film, Music, Books), Content Genre (eg for Music Rock, Jazz, for Film Action, Documentary), Theme (eg Beach, night time, Romantic), Country, City, Age Group, Sex.

Examples of consumer contextual data include but are not limited to Country, City, postcode, Date of Birth, favorite holidays, favorite sports, favorite music, favorite things and gadgets, favorite countries, favorite books, favorite films, favorite food, favorite web activities, favorite charities.

Examples of content contextual data include but are not limited to Label, Publisher, Artist, Genre, Theme, Mood, Brand Name Restrictions (eg no Target), Age restrictions (eg no less than 18), Brand Type Restrictions (No alcohol, No tobacco, No drugs).

In one embodiment, the system is an advertising system. The system of will preferably be computer implemented. As such, the system will normally be implemented on at least one computer including one or more processors, storage means and associated with one or more communications pathways.

The system may be implemented using devices with computer processors such as telephones, portable or desktop computers, personal data storage devices, MP3 and MP4 players, audiovisual storage and display devices, televisions and the like. Provided that a device that can access communications pathways for the downloading of content, that device may be used according to the system of the present invention.

One embodiment of the present invention is particularly adapted for delivery of content to a user according to the request of a user over an electronic or digital network. As such, it is particularly adapted for use in the field of television (subscriber or “pay” television or free to air), internet delivery, or even in flight entertainment (IFE) delivered to individual seats on a flight dependent upon the customer in that seat. According to the IFE embodiment; the customer will need to provide the system with customer parameters or login details to access customer parameters present in the system already in order for the system to recognize the customer. In this embodiment, the communications pathway is one between the customer's seat display or delivery mechanism and a database of the content and content is therefore “downloaded” from the database (normally a central database servicing the entire flight) to the customer's seat display or delivery mechanism. The present invention therefore may utilize an “open” communications network or a “closed” communications network.

Typically, the brand specific interface generation engine will be located on a network of computers such as the Internet. Indeed, the system will normally be accessed through a network of computers such as the Internet or a worldwide network.

Typically, the system will be accessed through an interface provided as a webpage located on a worldwide network of computers and accessible using any form of display means to display the interface and accept queries. This includes computers, PDA's, mobile phones and the like. In this way, the system can provide targeted advertising at a personal level to a large number of users simultaneously.

The system is adapted to provide tailored advertising through the provision of content which is preferred by consumers being linked with advertising from brands being associated with that content. Importantly, the brand association with the content will be a passive or non-disruptive association. The brand will be displayed on a custom produced and displayed interface bearing indicia representing the brand providing the content, but not disruptive, delaying or interrupting the content delivery.

Preferably, the system will be implemented across any network and will typically be network independent, with no network prevented from access to the system but no network preferred either.

The system will normally have a system administrator. The system administrator will typically have access to all parts of the system and may have access through the same interface as the other members of the system was through a stand alone, or separate specialised interface. Normally, the system administrator will have accessed through the same interface with the level of access of the system administrator differentiated by access on login information which will distinguish the system administrator from other users or members.

The system will therefore have members of at least the following general classes, as well as the system administrator:

1. consumers;

2. brand clients;

3. content providers.

The system has at least one consumer database containing a plurality of customer profiles with preference data. The at least one consumer database will typically be created and maintained by a system administrator, with the data in the database(s) updated and maintained mainly by the consumers themselves, once the consumers are members of the system.

Membership to the system for consumers will typically be free in response to the consumer providing information or creating a consumer profile. Typically, this will (once checked by the system administrator, typically by an automated system of the system administrator) allow the consumer access to the system. There may be different levels of consumer membership based on the amount of information provided by a consumer with a consumer who provides more, or more detailed information being provided with more privileges than a consumer that provides less information.

Each consumer will typically have a consumer profile containing information of two basic types namely, generic identifying information such as name, address, contact details and also habit or preference data such as age, likes and dislikes, music choices, brand preferences and the like.

Typically, the preference data may be captured or provided by a consumer directly, that is, in answer to direct questions as to their preferences.

Alternatively, the preference data may be captured or provided through surveys, testing or quizzes, for example in order to build a consumer preference profile for each consumer.

The consumer profile will typically therefore have a set of information which is more or less fixed, namely the generic identifying information (although it is anticipated that this set of information will change such as for example, if a consumer moves or changes addresses) and a set of variable information namely that their consumer preference information as the set of information is likely to change over time.

As mentioned above, membership to the system for the consumers will typically be through the system administrator although this process may be automated and systems provided to approve membership of consumers based on the information provided. There may additionally be an automated system which marks a consumer profile as “inactive” if the profile has not been updated or used for a particular period of time. This will preferably increase the motivation of consumers to maintain an active profile and also assist with ensuring that the consumer's preference profile is up to date.

Also as mentioned above, consumer membership is voluntary and consumers may join at any time. Consumers may have a single profile or multiple profiles. Consumer membership applications may be subject to screening by the system administrator. The most important part of the consumer membership is the provision of preference data and this may be a precondition for consumer membership.

The consumers may have access to their consumer profile through a consumer interface and access to the at least one consumer database will typically be according to login or access information which will give a consumer access to their own profile. Normally, the consumers will access the generic interface and access will be granted based on their login or identifying information with use of the system limited according to that information.

Consumers may typically amend their consumer data at any time which will normally upload to the at least one consumer database. Each consumer will typically be identified by their preference data with the only access to the consumer profiles by a third party being through the system administrator.

The system has at least one brand database containing details of brand clients, each having one or more branding parameters. A brand client may be a single entity or may include groups of one or more entities grouped according to shared quality or target audience. The “brand” of such a brand client is communicated to the user when they engage in any brand selection activity. For example, a brand client may be a collective of individual entities such as a group of real estate agents for example who all have a shared target. The brand parameters of such a brand client may therefore be settled on as a group of members of the brand client.

The brand clients may be members of the system through a third-party media or advertising agency or directly.

Membership to the system by the brand clients will normally occur along a similar basis to the consumer members but the brand clients will typically be provided with different abilities. Normally, the abilities or rights of the brand clients within the system will be determined by the brand client login or identifying information used, once the brand client becomes a member of the system.

Typically, brand clients will join the system in order to advertise by building a relationship with the consumer through an association with particular content which will also typically convey to the consumer, a particular positioning strategy of the brand client.

The brand clients may not be direct (that is active uploading) members of the system but may be pseudo-members of the system. For example, a brand client may have signed a representation agreement with a media or creative agency which will advise on a particular brand strategy. The brand client will still be a member of the system to the extent that the at least one brand database will contain information and identifying particulars of the brand client, but the interaction with the system on behalf of the brand client may be undertaken by the media or creative agency representing the brand client. In this case, the brand client will typically be a member of the system as the paying customer even though the media/creative agency may design and implement the marketing or branding strategy by managing the branding parameters within the system.

The brand clients (or a representative) will typically define their own brand personality and/or particular positioning strategy using the branding parameters. The personality or positioning strategy may be in relation to the brand as a whole or particular products or lines within a house brand.

The brand clients (or a representative) will also typically define their target demographic or geographic area.

The at least one brand database will preferably contain identifiers of the brand client for example company name and contact information and also the branding parameters which will preferably define the message which the brand wishes to convey to their targeted demographic. These branding parameters may be positively recited, such as “prefers name brand” or negatively recited, such as “non-smoking”.

The system has at least one content database containing pieces of content with each piece of content having one or more content profile identifiers.

The pieces of content should be considered to be anything of intrinsic or implied value that a user can “consume” specifically including but not limited to, music, audio, video, books or ebooks, games, applications (or “apps”), software “add-ons”, still images, snippets, services, redeemable vouchers, branded material, t-shirts, caps, tickets to events, information services or portions of the aforementioned.

For the purposes of the present description, the term “consume” includes downloading the content whether for immediate or delayed consumption, printing, or saving the content. However this language is not intended to be a limitation on the term consume but is merely explanatory in nature to assist the reader.

Basically, the content can have any form provided that the content is electronic or digital in order that the content can be transmissible between the system and the at least one consumer and between the at least one content provider and the system. Normally, each piece of content will be stored in an electronic file and it is this electronic file which will typically be capable of transmission, dissemination or copying or the like onto a physical medium.

The content will typically be provided from any source. For example, an entertainment studio, TV network, Internet social networking systems or record labels may choose to provide content to the system. Alternatively, smaller organisations or individuals may choose to provide content directly to the system such as home movies, demo music tracks or the like.

The content may be provided directly to the system or indirectly. Normally, the content provider will have to be or have a legal relationship with the content owner and systems will normally be provided to monitor the content in this regard to minimise the risk that content can be provided without the permission of the owner. Content provision shall include but not be limited to one time purchases, rentals, term subscriptions, use subscriptions, and rights limited ownership (e.g. DRM limited music and video).

Each piece of content will also have one or more content profile identifiers which will typically be referred to as “tags”. Each piece of content will also typically have identification or ownership information. Preferably, the ownership information identifies who owns the content in order to recompense the owner and the tags will identify the type of content.

Each piece of content will typically be tagged according to its “type”. Each piece of content will preferably be tagged according to its Genre, Mood, Style and Theme. For example, the Genre tags will normally be those used in a particular industry such as music genre including pop, classical, rock, rhythm and blues, house/techno, folk and the like. Each of these broad genre categories may include at one or more sub-genre. There are also typically genre associated with video games, television, film, literature and the like. Therefore, each piece of content will typically be tagged according to its broad type and then further tagged according to genre. Normally, the genre tagging will also fit with the accepted genres in industry.

Mood tagging will preferably represent the relatively long-lasting, effective or emotional state that the content offers for example fun, cheerful, humorous, gentle, scary, thought provoking, reflective and the like.

Style tagging will preferably identify the pieces of content for composition or format. Genres have been used to identify “style”, but one embodiment of the system of the present invention will typically tag the content with more complexity. For example, a song may be a rock genre song but maybe further classified using style tagging as modern rock or contemporary rock and may indicate the basic style of the entertainment content.

Theme tagging will typically identify the broad idea, message or lesson conveyed in the piece of content. For example the piece of content may be comforting, relaxing, suggestive or the like.

Importantly, tagging systems have been used conventionally but the tagging systems vary depending upon the provider of the content and the various entertainment types. The system will typically provide a standard for content tagging.

Content tagging may also be adjusted or performed through the monitoring of Internet searches or the like for example, through reviews, comments, links and categorisation. The present system therefore accounts for the fact that consumers will typically search the Internet for particular content and may use these searches and/or results to improve the accuracy of the content tagging. In this manner, the content tagging may be reactive. Typically, any content tagging will occur in real time as will adjustments to content tagging, as the popularity of particular content and/or preferences of a consumer will typically vary over time.

The content tag updates may be periodic or preferably ongoing in real time.

Preferably, each piece of content will be initially tagged upon uploading or the first provision of that piece of content to the system. There will typically be an analysis process upon uploading in order to check to see whether a particular piece of content which has been submitted is not already present on the system.

The tags for the piece of content may be changed or vary over time in response to feedback from consumers who have been provided with that piece of content. There may therefore be a feedback mechanism in place to question or follow-up with consumers who have been provided with a piece of content to request whether the piece of content was tagged in the correct way and/or that the tag is up-to-date. The tag updating process may be an automated process.

Each piece of content may have more than one tag but preferably, the number of tags will typically be limited to no more than between 5 to 10 tags. Tags may also be provided in different levels of importance with the number of tags in each level varying with the level of importance. For example, there may only be 5-10 top-level importance tags attached to a piece of content but that same piece of content may have 10-1000 less relevant or important tags.

The system includes a brand specific interface generation engine. The generation engine will typically operate according to one of two types of queries. The first type of query may be a consumer query for content where the consumer requests particular content. According to this aspect, the brand specific interface generation engine will search to find the particular content piece, then typically identify the content tags of the particular content requested and search the brand database for brand clients which are providing that content piece. The interface generation engine then checks to see whether the consumer identification matches the brand parameters. If there is a match, that brand is added to a list and the search moves on. If there is no match, the brand is dropped and the search moves on. The list may be displayed either as the search is conducted or at the conclusion of the search or part of the search.

The term “display” shall be used to indicate supply and or distribution of content to a consumer, and implicitly includes the default common mechanisms for supply and/or distribution appropriate for the nature of the content. The term “display” may be taken to mean view, download, stream, receive by email or tradition mail or courier services, as well as other germane mechanisms. However this explanation is not intended to be a limitation on the term display but merely explanatory in nature to assist the reader.

Once the brand list has been finalised (which maybe through a search of all brands or simply a certain number of brands or simply a certain number of certain type or of a certain type of brand) the list is provided to the consumer.

The consumer then typically chooses a brand to provide the content requested. The brand specific interface generation engine then preferably searches the brand client for its brand parameters. The generation engine then preferably uses those brand parameters and the consumer content query in order to select pieces of content from a content pool and generates a brand specific interface which includes the requested content and/or other content which matches the content tags for the content requested as well as the brand parameters for the brand providing the content requested.

The brand is preferably also displayed on the interface. Typically, the brand is provided without advertising specific to that brand. Where provided, advertising is non disruptive or passive advertising.

The second type of query may be a consumer brand query in which a consumer searches for a particular brand. The brand specific interface generation engine then searches for the brand client and examine the brand client parameters. The generation engine will then typically search the content database for content which matches the brand parameters. The generation engine will typically search a variety of different content types and selects a random combination of matching content from the pool. The generation engine then uses this random combination to generate an interface displaying the brand and the selected pieces of content. The consumer may then view or display content from this interface, preferably without disruptive, interruptive or delaying advertising.

Typically, charging occurs when the consumer downloads or views the content and a brand client is normally not charged for the mere display of the content on the interface.

The content provided typically has no direct association with the brand. For example, a brand interface will preferably not display advertising content by the brand owner. Therefore, if Coca-Cola is the brand client, as the generation engine will not display Coca-Cola advertisements. Instead, the content will preferably portray or convey the preferred Coca-Cola branding parameters which may be “young, hip, fun, carefree”. The content may therefore be audiovisual of skating or surfing content as the convey the required branding parameters.

The brand specific interface generation engine may be used in association with a spine and rib cage selector. According to this embodiment, the brand client will typically select a number of representative content pieces which communicate the brand persona to a consumer. This sample is then typically used to select other pieces of content from the general pool, which matched the content tags of the representative content pieces and therefore also represent the brand persona. They select several of the matching content is then displayed on the brand specific interface from which the consumer can select content based on their preference data.

The content selection process may include new trend data as well and content directed towards new or emerging trends may allow a brand client to direct or at least guide existing consumers in the direction of the new trend.

The brand client will therefore preferably build rapport with the consumer by providing content which conveys an association rather than through the direct provision of advertising content of the brand client to the consumer.

The method and system of the preferred embodiment will typically provide a transactional model allowing content to be accessed/downloaded by a consumer provided that the content matches the consumer's search preferences, and that the consumer fits within the brand client's preference parameters. The method and system will therefore check the consumer profile prior to releasing the content for download and compare the consumer profile with the branding parameters entered by the brand client. The method and system also tracks the content downloaded, and enables payment to content owners once download has been authorised.

There will therefore be a request by consumer in the form of a search, authorisation of the download of the content provided that the consumer's profile matches the branding parameters of the brand client, and once the download is complete (or upon authorisation of the download) the method and system will also authorise the payment of remuneration to the content owner, through a third party if required.

Authentication of identity systems may be used in conjunction with the system of the present invention. There are many of these systems available and any may be used to authenticate the identity of members of any of the groups associated with the system. The authentication system will typically be integrated with the transaction system and the consumer request, uploading of content and provision of content sub-systems.

The depth of association can be chosen by the brand client. The depth can be varied by the brand client choosing whether it wants to choose a percentage (%) or degree of variation from the content requested, eg 0%, 10%, 20% etc. The list matching step can then be broadened or shrunk (still based on the content requested) depending on the depth of association chosen. This depth preferably defines what content the brand client will pay for.

It also preferably defines how closely a piece of content should match the content requested before appearing in the brand specific interface. A brand client can therefore adjust the depth of content to reach more consumers (by reducing the depth required) with a corresponding weakening of the message conveyed or provide a stronger message to fewer consumers by increasing the depth of association required.

In an preferred embodiment, the method may be associated with a computer implemented method of generating a pool of matched content pieces from an available pool of content pieces based on a selected sample, the method including the steps of:
providing at least one consumer database containing a plurality of consumer profiles with consumer preference identifying data stored on a data storage device,
providing at least one brand database containing details of brand clients, each having one or more branding parameters stored on a data storage device,
providing at least one content database containing a plurality of pieces of content provided by at least one content provider with each piece of content having one or more content profile identifiers stored on a data storage device,
selecting a number of representative content pieces based on one or more branding parameters of a brand client to convey a brand identity,
testing the representative content pieces against a set of constraints based on one or more content profile identifiers to establish that a minimum number of content pieces are present in the available pool of content pieces using a data processor, and
generating a pool of matched content pieces by selecting a plurality of content pieces from the available pool based on comparing the one or more content profile identifiers of the representative content pieces with one or more content profile identifiers of each content piece in the available pool of content pieces and including matches in the matched content pool using a data processor.

The brand specific interface is then preferably generated by a data processor by matching at least one branding parameter of a brand client with one or more pieces of content and displaying the pieces of content on a branded interface presented to a consumer at no cost to the consumer whilst charging an advertising fee to the brand client and paying a content provision fee to the content provider, the content provided without branding disrupting or interrupting the content and drawn from the matched content pool.

The system of the present invention can similarly be associated with a computer implemented content matching system for generating a pool of matched content pieces from an available pool of content pieces based on a selected sample, the system including:
at least one consumer database containing a plurality of consumer profiles with consumer preference identifying data stored on a data storage device,
at least one brand database containing details of brand clients, each having one or more branding parameters stored on a data storage device,
at least one content database containing a plurality of pieces of content provided by at least one content provider with each piece of content having one or more content profile identifiers stored on a data storage device,
a content matching engine operating in association with a data processor which compares the one or more content profile identifiers of a number of representative content pieces chosen by a brand client to convey a brand identity based on one or more branding parameters of the brand client with one or more content profile identifiers of each content piece in the available pool of content pieces, tests the representative content pieces against a set of constraints based on one or more content profile identifiers to establish that a minimum number of content pieces are present in the available pool of content pieces, and generates a pool of matched content pieces by selecting a plurality of content pieces from the available pool based on the comparison and includes matches in the matched content pool.

The brand specific interface generation engine then operates in association with a data processor, and which generates the brand specific interface by matching at least one branding parameter of a brand client with one or more pieces of content and displays the pieces of content on a branded interface presented to a consumer at no cost to the consumer whilst charging an advertising fee to the brand client and paying a content provision fee to the content provider, the content provided without branding disrupting or interrupting the content and drawn from the matched content pool.

The “Spine and Rib” concept is one solution to the problem of selecting content for a brand channel while making the selection broad enough to cover a wide range of content, dynamic enough to enable targeting of consumers that fit the brand channel audience on an ongoing basis and to have the depth of content that reflects the brands personality.

A Spine is a small selection of content that represents the core or quintessential content for the brand channel.

A Ribcage defines the brands association to a particular media context. It is a list of matched content that a brand will pay for the consumer to download and specifies the degree of relatedness of the brand and content with each piece of content constituting a “Rib”.

The matching may occur on the basis of a degree of matching calculated as a quantitative value. Each content piece preferably has one or more content profile identifiers. The brand client may choose content pieces as representative of their brand parameters, or the brand parameters may include one or more content profile identifiers and preferably a value for each content profile identifier.

The content profile identifiers may be used as a base to calculate a degree of matching. According to one preferred embodiment, each content profile identifier may be given a weighting factor or ranking. A numerical or other quantitative value can then given to each piece of content in each content profile identifier which together with the weighting factor or ranking of the each content profile identifier can be used to calculate a value or set of values related to the each content profile identifiers for each piece of content. By selecting a representative set of content or by designating a value or values for the content profile identifiers, the brand client may define a representative value or set of values for the matching.

This value or set of values can then be used to calculate a degree of matching of the content pieces with the branding parameters by using the variation in the content profile identifiers of each content piece from those chosen by the brand client. For example, once the one or more content profile identifiers and preferably a value for each content profile identifier has been designated by the brand client, the value or set of values for each piece of content can be compared to this value or values as to whether the potential piece of content is included in the match or not depending on the variation.

Of course, any selection of content may be manual but is preferably automatic according to the method of the invention. Manual selections may be made in addition to the automatic selections.

The content profile identifiers may be or include non-numerical tags or contextual data. The brand client may also set a threshold degree of matching required in order for a content piece to be included as a match.

The degree of association calculation may therefore be based on a comparison base of:
the presence or absence of one or more content profile identifiers (whether numerical or non-numerical);
the relative importance of one or more content profile identifiers in relation to one or more other content profile identifiers; and/or
a value or set of values related to the content profile identifiers for each piece of content,
   with the same comparison base chosen by the brand client.

Embodiments of the present invention are distinguishable from the vast majority of other delivery systems for many reasons including but not limited to:
1. the manner in which the content and the matched advertising is selected by the system;
2. the delivery of the content with the advertising in a non-disruptive manner; and
3. that the customer chooses the advertising to be viewed when they choose the brand client associated with the content.

Any of the features described herein can be combined in any combination with any one or more of the other features described herein within the scope of the invention.

### BRIEF DESCRIPTION OF THE DRAWINGS

Various embodiments of the invention will be described with reference to the following drawings, in which:

FIG. 1A is a schematic view of one form of content delivery with disruptive advertising delivery.

FIG. 1B is a schematic view of a second form of content delivery with disruptive advertising delivery.

FIG. 1C is a schematic illustration of a brand channel interface with content provided on a branded interface bearing indicia of a brand client providing the content.

FIG. 2 is a schematic representation of an algorithm for producing and displaying a brand specific interface displaying content representing a brand persona.

FIG. 3 is a schematic representation of an algorithm for producing and displaying a pool of matched content pieces representing a brand persona from an available pool of content pieces based on a selected sample.

### DETAILED DESCRIPTION OF THE PREFERRED EMBODIMENT

According to each of the preferred embodiments illustrated, a system for producing and displaying content representing a brand persona is provided.

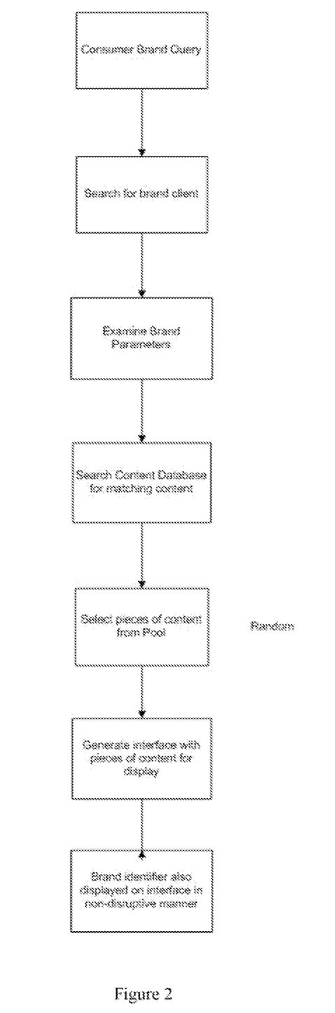

According to the embodiment illustrated in FIG. 2, a computer implemented brand specific interface generating system for producing and displaying content representing a brand persona, the system including at least one consumer database containing a plurality of consumer profiles with consumer preference identifying data stored on a data storage device, at least one brand database containing details of brand clients, each having one or more branding parameters stored on a data storage device, at least one content database containing a plurality of pieces of content provided by at least one content provider with each piece of content having one or more content profile identifiers stored on a data storage device, and a brand specific interface generation engine operating in association with a data processor, and which generates the brand specific interface by matching at least one branding parameter of a brand client with one or more pieces of content and displays the pieces of content on a branded interface presented to a consumer at no cost to the consumer whilst charging an advertising fee to the brand client and paying a content provision fee to the content provider, the content provided without branding disrupting or interrupting the content.

The generation engine will typically operate according to one of two types of queries.

The first type of query may be a consumer brand query in which a consumer searches for a particular brand and for which the solution algorithm is illustrated in FIG. 2. The brand specific interface generation engine then searches for the brand client and examine the brand client parameters. The generation engine will then typically search the content database for content which matches the brand parameters. The generation engine will typically search a variety of different content types and selects a random combination of matching content from the pool. The generation engine in uses this random combination to generate an interface displaying the brain and the selected pieces of content. The consumer may then view or display content from this interface.

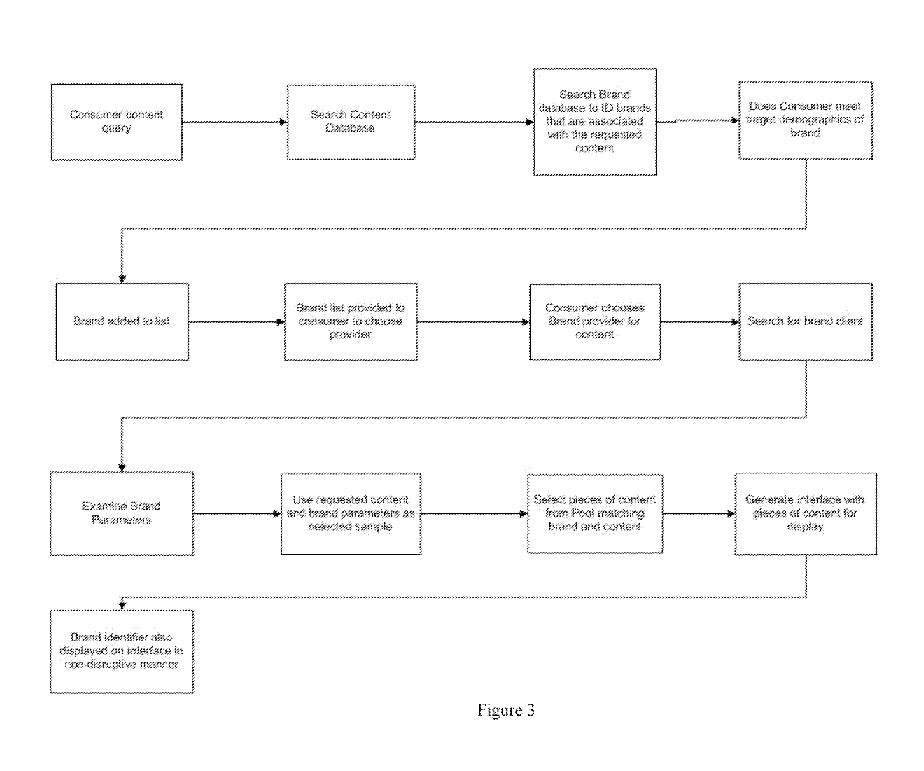

The second type of query may be a consumer query for content where the consumer requests particular content and for which one solution algorithm is illustrated in FIG. 3. According to this aspect, the brand specific interface generation engine will search to find the particular content piece, then typically identify the content tags of the particular content requested and search the brand database for brand clients which are providing that content piece. The interface generation engine then checks to see whether the consumer identification data matches the brand parameters. If there is a match, that brand is added to a displayed list and the search moves on. If there is no match, the brand is dropped and the search moves on.

Once the brand list has been finalised (which may be through a search of all brands or simply a certain number of brands or simply a certain number of certain type or of a certain type of brand) the list is provided to the consumer.

The consumer then typically chooses a brand to provide the content requested. The brand specific interface generation engine then preferably searches the brand client for its brand parameters. The generation engine then preferably uses those brand parameters and the consumer content query in order to select pieces of content from a content pool and generates a brand specific interface which includes the requested content and/or other content which matches the content tags for the content requested as well as the brand parameters for the brand providing the content requested.

The brand is preferably also displayed on the interface. Typically, the brand is provided without advertising specific to that brand. Where provided, advertising is non disruptive or passive advertising. The brand association with the content will be a passive or non-disruptive association. The brand is displayed on a custom produced and displayed interface, bearing indicia representing the brand providing the content, but not disrupting, delaying or interrupting the content delivery.

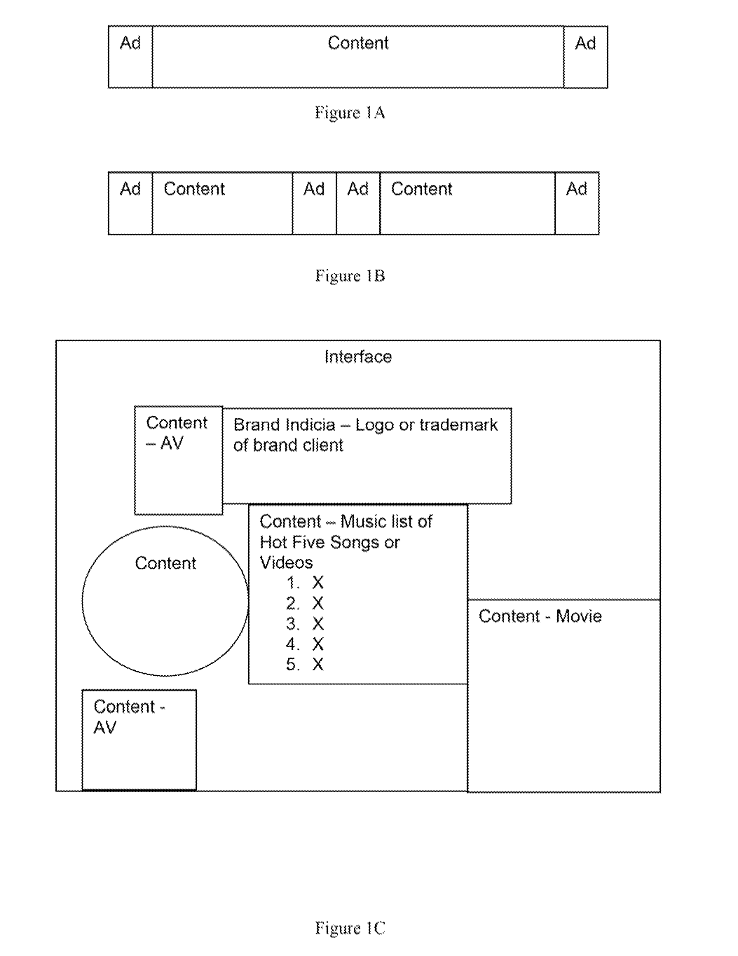

A schematic example of a brand specific interface is illustrated in FIG. 1C. The consumer can then choose delivery of any of the content on the interface and the content is provided. The interface also contains additional content related to that requested and which also conveys the brand persona. In this way the consumer is provided with additional content that may convey the brand persona to them or positively reinforce the brand in the eyes of the consumer.

When the content is selected for delivery, a second interface may be presented to display the content and it is preferred that this is a branded interface as well but with the brand indicia being less conspicuous.

In this way the consumer is delivered the content contemporaneously with the branding rather than after or interspersed with the branding.

Typically, charging occurs when the consumer downloads or views the content and a brand client is not charged for the display of the content on the interface.

The content provided typically has no direct association with the brand. For example, a brand interface will preferably not display advertising content by the brand owner. Therefore, if Coca-Cola is the brand client, the generation engine will not display Coca-Cola advertisements. Instead, the content will preferably portray or convey the preferred Coca-Cola branding parameters which may be “young, hip, fun, carefree”. The content may therefore be audiovisual of skateboarding or surfing content as they convey the required branding parameters.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

Embodiments of the invention have been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A computer implemented method for producing and displaying content representing a brand persona, the method comprising:
providing at least one consumer database containing a plurality of consumer profiles with consumer preference identifying data stored on a data storage device,
providing at least one brand database containing details of brand clients, each having one or more branding parameters stored on a data storage device,
providing at least one content database containing a plurality of pieces of content provided by at least one content provider with each piece of content having one or more content profile identifiers stored on a data storage device,
a brand specific interface accessible by at least one consumer, the brand specific interface generated by a data processor by matching at least one branding parameter of a brand client with one or more pieces of content and displaying the pieces of content on a branded interface presented to a consumer at, no cost to the consumer whilst charging an advertising fee to the brand client and paying a content provision fee to the content provider, the content provided without the branding disrupting or interrupting the content.

2. A computer implemented method as claimed in claim 1, wherein a results list is displayed allowing the at least one consumer to choose the brand client whose branded interface is displayed with the one or more pieces of content which match the at least one consumer's search.

3. A computer implemented method as claimed in claim 1, wherein contextual data tags are provided for the at least one brand, the at least one consumer, and each piece of content.

4. A computer implemented method as claimed in claim 1, wherein the brand specific interface generation engine operates according to a consumer query for content where the consumer requests particular content.

5. A computer implemented method as claimed in claim 4, wherein the brand specific interface generation engine searches the at least one content database to find the particular content, then identifies the content profile identifiers of the particular content requested and searches the brand database for brand clients which are providing that particular content piece, checks to see whether the consumer preference identifying data matches at least one of the branding parameters and if there is a match, that brand is added to a match list and the search moves on, if there is no match, the brand is dropped and the search moves on.

6. A computer implemented method as claimed in claim 5, wherein the match list is provided to the consumer allowing the consumer to choose a brand client to provide the content requested.

7. A computer implemented method as claimed in claim 6, wherein the brand specific interface generation engine searches the brand client for its branding parameters and uses those brand parameters and the consumer content query in order to select pieces of content from a content pool and generates a brand specific interface which includes the requested content and/or other content which matches the content tags for the content requested as well as the brand parameters for the brand providing the content requested.

8. A computer implemented method as claimed in claim 1, wherein the brand specific interface generation engine operates according to a consumer brand query in which a consumer searches for a particular brand.

9. A computer implemented method as claimed in claim 8, wherein the brand specific interface generation engine then searches the at least one brand database for the brand client and examines the brand client for its branding parameters, searches the at least one content database for content which matches the branding parameters, selects a random combination of matching content from at least one content database and uses this random combination to generate an interface displaying the brand and the random combination of matching content.

10. A computer implemented method as claimed in claim 1, wherein charging occurs when the consumer downloads or views the content and a brand client is not charged for the mere display of the content on the interface.

11. A computer implemented method as claimed in claim 1, wherein the brand specific interface generation engine is used in association with a spine and rib cage selector in which the brand client selects a number of representative content pieces which communicate a brand persona to a consumer, this sample is then used to select other pieces of content from the general pool, which match the content profile identifiers of the representative content pieces and therefore also represent the brand persona, and the matching content is then displayed on the brand specific interface from which the consumer can select content based on their preference data.

12. A computer implemented method as claimed in claim 1, wherein the matching occurs on the basis of a degree of matching calculated as a quantitative value.

13. A computer implemented method as claimed in claim 12, wherein each content profile identifier of each piece of content is given a weighting factor or ranking and a quantitative value is given to each piece of content in relation to each content profile identifier.

14. A computer implemented method as claimed in claim 13, wherein the quantitative value is a numerical value.

15. A computer implemented method as claimed in claim 13, wherein the quantitative value is or includes non-numerical contextual data.

16. A computer implemented method as claimed in claim 13, wherein the quantitative value together with the weighting factor or ranking of each content profile identifier is used to calculate a value, or set of values related to each content profile identifier, for each piece of content.

17. A computer implemented method as claimed in claim 16, wherein the value, or set of values, is used to calculate a degree of association of the content requested with other content pieces in the at least one content database by using the variation of the value, or set of values related to the content requested compared to the value, or set of values related to the other content pieces in the at least one content database and including a content piece in brand specific interface based on the degree of association.

18. A computer implemented method as claimed in claim 1, wherein the depth of association is chosen by a brand client.

19. A computer implemented method as claimed in claim 18, wherein the contents of the brand specific interface is varied by the brand client choosing a degree of association that must be satisfied before including a content piece in the brand specific interface.

20. A computer implemented brand specific interface generating system for producing and displaying content representing a brand persona, the system comprising:
at least one consumer database containing a plurality of consumer profiles with consumer preference identifying data stored on a data storage device,
at least one brand database containing details of brand clients, each having one or more branding parameters stored on a data storage device,
at least one content database containing a plurality of pieces of content provided by at least one content provider with each piece of content having one or more content profile identifiers stored on a data storage device, and
a brand specific interface generation engine operating in association with a data processor, and which generates the brand specific interface by matching at least one branding parameter of a brand client with one or more pieces of content and displays the pieces of content on a branded interface presented to a consumer at no cost to the consumer whilst charging an advertising fee to the brand client and paying a content provision fee to the content provider, the content provided without branding disrupting or interrupting the content.

21. A computer implemented method for producing and displaying a pool of matched content pieces representing a brand persona from an available pool of content pieces based on a selected sample, the method comprising:
providing at least one consumer database containing a plurality of consumer profiles with consumer preference identifying data stored on a data storage device,
providing at least one brand database containing details of brand clients, each having one or more branding parameters stored on a data storage device,
providing at least one content database containing a plurality of pieces of content provided by at least one content provider with each piece of content having one or more content profile identifiers stored on a data storage device,
selecting a number of representative content pieces based on one or more branding parameters of a brand client to convey a brand identity,
testing the representative content pieces against a set of constraints based on one or more content profile identifiers to establish that a minimum number of content pieces are present in the available pool of content pieces using a data processor,
generating a pool of matched content pieces by selecting a plurality of content pieces from the available pool based on comparing the one or more content profile identifiers of the representative content pieces with one or more content profile identifiers of each content piece in the available pool of content pieces and including matches in the matched content pool using a data processor
generating a brand specific interface using a data processor by matching at least one branding parameter of a brand client with one or more pieces of content and displaying the pieces of content on a branded interface presented to a consumer at no cost to the consumer whilst charging an advertising fee to the brand client and paying a content provision fee to the content provider, the content provided without branding disrupting or interrupting the content and drawn from the matched content pool.

22. A computer implemented brand specific interface generating system for producing and displaying a pool of matched content pieces representing a brand persona from an available pool of content pieces based on a selected sample, the system comprising:
at least one consumer database containing a plurality of consumer profiles with consumer preference identifying data stored on a data storage device,
at least one brand database containing details of brand clients, each having one or more branding parameters stored on a data storage device,
at least one content database containing a plurality of pieces of content provided by at least one content provider with each piece of content having one or more content profile identifiers stored on a data storage device,
a content matching engine operating in association with a data processor which compares the one or more content profile identifiers of a number of representative content pieces chosen by a brand client to convey a brand identity based on one or more branding parameters of the brand client with one or more content profile identifiers of each content piece in the available pool of content pieces, tests the representative content pieces against a set of constraints based on one or more content profile identifiers to establish that a minimum number of content pieces are present in the available pool of content pieces, and generates a pool of matched content pieces by selecting a plurality of content pieces from the available pool based on the comparison and includes matches in the matched content pool and
a brand specific interface generation engine in association with a data processor, and which generates the brand specific interface by selecting one or more pieces of content and displays the pieces of content on a branded interface presented to a consumer at no cost to the consumer whilst charging an advertising fee to the brand client and paying a content provision fee to the content provider, the content provided without branding disrupting or interrupting the content and drawn from the matched content pool.
